(19) United States
(12) Patent Application Publication
(10) Pub. No.: US 2003/0146906 A1
(43) Pub. Date: Aug. 7, 2003

(54) Tracking and pressure-sensitive digital pen

(76) Inventor: Chung-Chen Lin, Hsin-Chu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/061,255

(22) Filed: Feb. 4, 2002

(51) Int. Cl. G09G 5/00

(52) U.S. Cl. 345/179

(57) ABSTRACT

A digital pen with tracking and pressure-sensitive functions comprises a pen core with a tracking module in the digital pen. The tracking module is used for detecting the pen core shifted in a direction with an optical signal. A pressure-sensitive module is connected with the pen core, which is used for detecting the pen core under a pressure and shifted relatively to the digital pen, and converting the pressure into an electric signal.

### BACKGROUND OF THE INVENTION

1. Field of the Invention

This invention relates in general to a point device, more particularly, relates to a digital pen capable of handwriting input.

2. Description of the Prior Art

Pointing devices, such as a mouse or a trackball, are well known peripheral devices in data processing environments. Pointing devices allow for cursor manipulation on a visual display screen of a personal computer or workstation, for example. Cursor manipulation includes actions such as rapid relocation of a cursor from one area of the display screen to another area or selecting an object on a display screen.

In a conventional electromechanical mouse environment, a user controls the cursor by moving the electromechanical mouse over a reference surface, such as a rubber mouse pad so that the cursor moves on the display screen in a direction and a distance that is proportional to the movement of the electromechanical mouse. The electromechanical mouse, however, has drawbacks associated with many other devices that have mechanical parts.

An optical mouse reduces, and in some instances eliminates, the number of mechanical parts. A conventional optical mouse uses a lens to generate an image of a geometric pattern located on an optical reference pad. The conventional optical mouse uses a light beam to illuminate an optical reference pad having a special printed mirror geometric pattern. The geometric pattern is typically a grid of lines or dots that are illuminated by the light source and then focused by a lens on a light detector in the conventional optical mouse. The conventional optical mouse provides the advantage of reducing or eliminating the number of mechanical parts. However, in U.S. Pat. No. 6,256,016 discloses several drawbacks about the conventional optical mouse.

Furthermore, the pressure from handwriting is not represented through the conventional optical mouse. And, it is not convenient for people to carry a mobile electric apparatus, such as a notebook, with an optical mouse because of its large size.

### SUMMARY OF THE INVENTION

In accordance with the present invention, a tracking and pressure-sensitive digital pen is provided for replacing a mouse and a digitizer or tablet.

Accordingly, one object of the present invention is to provide a tracking and pressure-sensitive digital pen for tracking the trace thereof with optical devices that can reduce the condition of footprint.

Another object of the present invention is to provide a digital pen for handwriting input. The digital pen detects handwriting pressure by variances in inductance or signal of optical brightness.

In accordance with the present invention, a digital pen with tracking and pressure-sensitive functions comprises a pen core with a tracking module in the digital pen. The tracking module is used for detecting the pen core shifted in a direction with an optical signal. A pressure-sensitive module is connected with the pen core, which is used for detecting the pen core under a pressure and shifted relatively to the digital pen, and converting the pressure into an electric signal.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram illustrating the optical portion of a digital pen in accordance with the present invention;

FIG. 2 is a schematic diagram of an embodiment illustrating the portion of optical devices in accordance with the present invention;

FIG. 3 is a cross-sectional schematic diagram illustrating the pressure-sensitive portion of the digital pen in accordance with the present invention;

FIG. 4 is a cross-sectional schematic diagram of another embodiment illustrating the pressure-sensitive portion of the digital pen in accordance with the present invention;

FIG. 5 is a cross-sectional schematic diagram of another embodiment illustrating the pressure-sensitive portion of the digital pen in accordance with the present invention; and

FIG. 6 is a cross-sectional schematic diagram of another embodiment illustrating the pressure-sensitive portion of the digital pen in accordance with the present invention.

### DESCRIPTION OF THE PREFERRED EMBODIMENT

Some sample embodiments of the invention will now be described in greater detail. Nevertheless, it should be noted that the present invention can be practiced in a wide range of other embodiments besides those explicitly described, and the scope of the present invention is expressly not limited except as specified in the accompanying claims.

A digital pen with tracking and pressure-sensitive functions comprises a pen core with a tracking module in the digital pen. The tracking module is used for detecting the pen core shifted in a direction with an optical signal. A pressure-sensitive module is connected with the pen core, which is used for detecting the pen core under a pressure and shifted relatively to the digital pen, and converting the pressure into an electric signal.

FIG. 1 is a schematic diagram illustrating the optical portion of a digital pen in accordance with the present invention. In a preferred embodiment, a pointing device, such as a digital pen, is an optical digital pen in accordance with the present invention. Depicted in FIG. 1, a pen core 11 is surrounded by a pen casing 10, both of which are movable relatively with each other. For example, when the pen core 11 is touched a touch pad 19 and pressured by a user, it can retract back into the pen casing 10 by moving relatively.

Furthermore, in the embodiment, the pen core 11 has a core chamber 12 wherein has a capacity of a light source 13, a photosensitive device 16 and a reflector 14. It is known that there are other devices and affixtures in the core chamber 12 and not shown in the figure.

Furthermore, the pen core 11 near the touch pad 19 has an opening or an opening covered with any transparent material that enables light to penetrate or reflect. The light source, such as a LED, emits a light beam 17 onto the touch pad 19. Through the reflector 14, a reflective light beam 18 from the touch pad 19 enters vertically into a photosensitive area 15 of the photosensitive device 16. In the present invention, there may be other optical devices for requirement on the path of light beam 17, as long as the core chamber 12 has enough space therein. Further, the touch pad 19 is capable of reflecting the light beam 17 or changing the reflective angle of the light beam 17.

Furthermore, a key feature of the present invention is the photosensitive device 16, such as a CMOS and peripheral circuits thereof. In a general optical mouse, the photosensitive area 15 of the photosensitive device 16 is relatively parallel to the reflective surface of the touch pad 19, which enables a reflective light beam to enter vertically therein. Unfortunately, a general digital pen has no space enough to put the photosensitive area 15 parallel to the touch pad 19. Thus, on consideration of the digital pen with a compact volume, the photosensitive area 15 of the present invention is corresponded to the touch pad at an angle, such as 90 degree in the embodiment.

Due to the angle for the photosensitive area 15 and the touch pad 19, the reflector 14 is responsible to change the path of the reflective light beam 18 and lets the reflective light beam 18 enter vertically into the photosensitive area 15, thus reduces the phenomenon of footprint for the optical digital pen. That is, the present invention provides the optical digital pen occupies less area than a general optical mouse does. It is not limited that there are other optical devices on the path of the reflective light beam 18. However, the reflector 14 of the present invention controls the reflective light beam 18 to ultimately enter vertically into the photosensitive area 15. That is, in accordance with the present invention, the light beam 17 is ultimately back to the photosensitive device 16 through at least twice reflections. Thus, with coordination of the optical devices, the digital pen of the present invention is capable of tracking the movement along the touch pad 19.

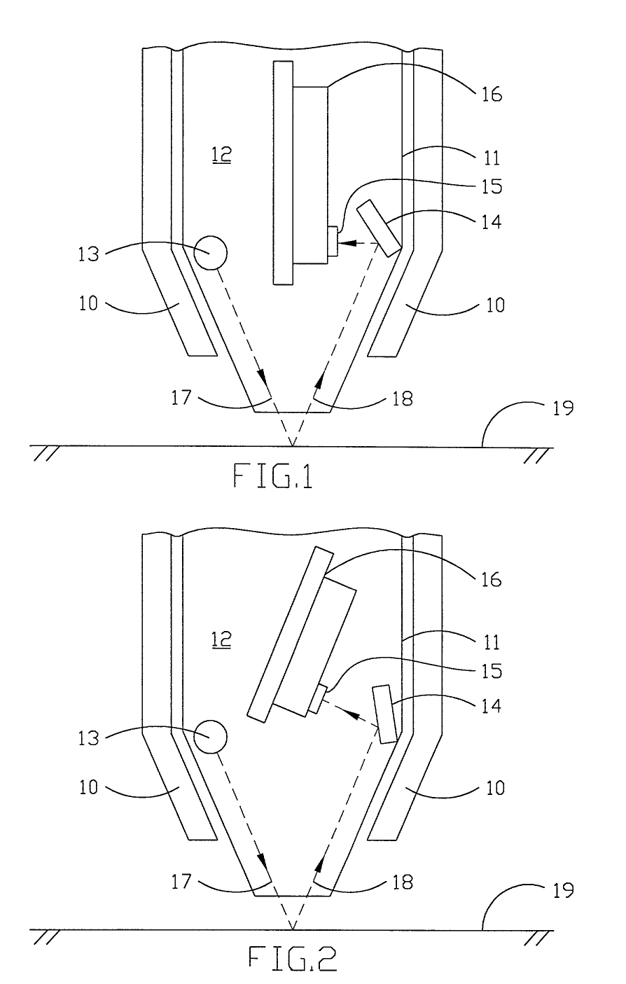

FIG. 2 is a schematic diagram of an embodiment illustrating the portion of optical devices in accordance with the present invention. The photosensitive area 15 of the photosensitive device 16 is corresponded to the touch pad 19 at an angle less than 90 degree. The reflector 14 is adjustable to enable the reflective light beam 18 change the path and enter vertically into the photosensitive area 15. Thus, no matter how the photosensitive area 15 needs to be coordinated to other devices or affixtures, the reflector 14 of the present invention can conduct the light beam 17 back vertical to the photosensitive area 15 through at least twice reflections.

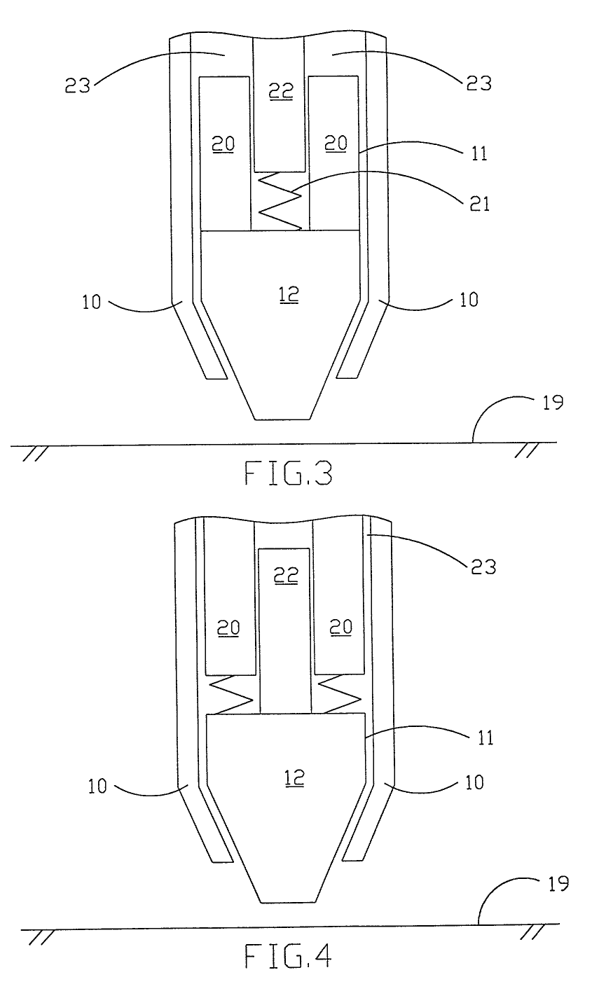

FIG. 3 is a cross-sectional schematic diagram illustrating the pressure-sensitive portion of the digital pen in accordance with the present invention. To be specific, the present invention provides both the tracking and pressure-sensitive functions with optical and photosensitive devices, individually. When the pressure-sensitive devices are illustrated in FIG. 3, the optical portion of the present invention is not shown for simplicity. Furthermore, the layout of peripheral circuits coordinated to the pressure-sensitive devices or other affixtures are not shown on the figure for simplicity, either. It is not limited within the figure.

Depicted as FIG. 3, in an embodiment, the pen casing 10 surrounds a cannular portion wherein comprises the pen core 11 with the core chamber 12 and a front body chamber 23. The core chamber 12 comprises the optical devices (not shown) mentioned in FIGS. 1 and 2, and the pen core 11 is capable of relatively moving up and down within the pen casing 10. The front body chamber 23 comprises an iron powder core 22 at the center of the front body chamber, and a conductive coil 20 surrounding the iron powder core 22. In the embodiment, one terminal of the iron powder core 22 is connected to the pen core 11 through an elastic device 21, such as a spring, while the other terminal of the iron powder core 22 is affixed to the front body chamber 23. The conductive coil 20 has one terminal connected directly to the pen core 11 and the other one suspended in the front body chamber 23. In the embodiment, variable inductance generates through the iron powder core 22 combined with the elastic device 21 and the conductive coil 20.

When the pen core 11 is touched onto the touch pad 19 and pressured by a user, the iron powder core 22 is not changed its horizontal level because it is affixed to the front body chamber 23. That is, the iron powder core 22 is static relatively to the pen core 11. On the other hand, due to direct connection with the pen core 11, the conductive coil 20 is changed its horizontal level accordingly through the deformation of the elastic device 21. For the iron powder core 22, the location of the conductive coil 20 is changed corresponding thereto. When the corresponding location for the conductive coil 20 and the iron powder core 22 is changed, a coil inductance is generated and further an oscillating frequency is changed accordingly. The oscillating frequency is processed through its peripheral circuit and is used for reading out the amount of the pressure.

FIG. 4 is a cross-sectional schematic diagram of another embodiment illustrating the pressure-sensitive portion of the digital pen in accordance with the present invention. Different from FIG. 3, one terminal of the conductive coil 20 is connected to the pen core 11 through an elastic device 21, while the other terminal (not shown) of the conductive coil 20 is affixed to the front body chamber 23. The iron powder core 22 has one terminal connected directly to the pen core 11 and the other one suspended in the front body chamber 23. When the pen core 11 is pressured, the iron powder core 22 is changed its horizontal level through the deformation of the elastic device 21. Thus, the coil inductance is generated according the corresponding changed location and further the oscillating frequency is changed accordingly.

FIG. 5 is a cross-sectional schematic diagram of another embodiment illustrating the pressure-sensitive portion of the digital pen in accordance with the present invention. The pen casing 10 surrounds a cannular portion wherein comprises the pen core 11 with the core chamber 12 and a front body chamber 23. The core chamber 12 comprises the optical devices (not shown) mentioned in FIGS. 1 and 2, and the pen core 11 is capable of relatively moving up and down within the pen casing 10. The front body chamber 23 comprises a structure 24 at the center and two separated structure 27 at the outside of the structure 24. one terminal of the structure 24 is connected to the pen core 11 through an elastic device 21, such as a spring, while the other terminal (not shown) of the structure 24 is affixed to the front body chamber 23. The each structure 27 has one terminal connected directly to the pen core 11 and the other one suspended in the front body chamber 23. In the embodiment, materials of the structures 24 and 27 are not limited. The structure 24 has a hollow light path 25. One of the structures 27 has a light emitter 26 for emitting a light beam, the other has a light acceptor 28 for accepting light signal at a same level as the light emitter 26. Under a specific conduction, the light beam from the light emitter 26 can be captured by the light acceptor 28 through the light path 25.

When the pen core 11 is touched onto the touch pad 19 and pressured by a user, the structure 24 is not changed its horizontal level because it is affixed to the front body chamber 23. That is, the structure 24 is static relatively to the pen core 11. On the other hand, due to direct connection with the pen core 11, the structures 27 are synchronously changed their horizontal level accordingly through the deformation of the elastic device 21. For the structure 24, the locations of the structures 27 are changed corresponding thereto. When the light emitter 26 and the light acceptor 28 are synchronously shifted up and down, the brightness of the light beam through the light path 25 is changed according to the shifting, thus the amount of light accepted by the light acceptor 28 is changed. The light accepted by the light acceptor 28 is processed through its peripheral circuit and can be read out the amount of the pressure. Furthermore, the width of the light path 25 is dependent on the pressure measured, as long as the brightness of the light corresponding to the pressure is measurable.

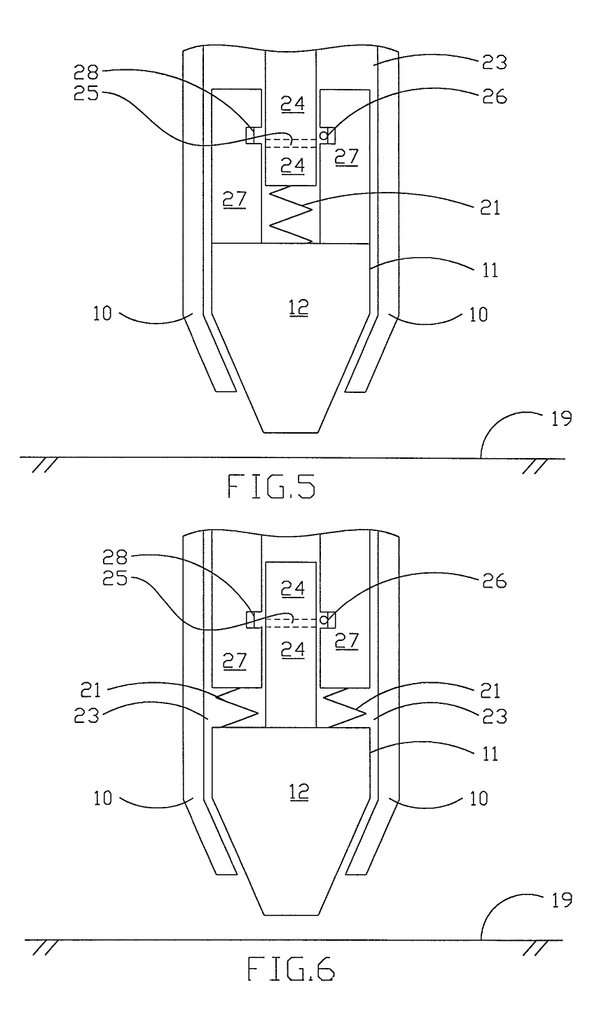

FIG. 6 is a cross-sectional schematic diagram of another embodiment illustrating the pressure-sensitive portion of the digital pen in accordance with the present invention. Different from FIG. 5, one terminal of each structure 27 is connected to the pen core 11 through an elastic device 21, while the other terminal (not shown) is affixed to the front body chamber 23. The structure 24 has one terminal connected directly to the pen core 11 and the other one suspended in the front body chamber 23. When the pen core 11 is pressured, the structure 24 is changed its horizontal level through the deformation of the elastic device 21. Thus, the light path 25 of the structure 24 is shifted up and down corresponding to the light emitter 26 and the light acceptor 28.

Although specific embodiments have been illustrated and described, it will be obvious to those skilled in the art that various modifications may be made without departing from what is intended to be limited solely by the appended claims.

What is claimed is:

1. A digital pen with tracking and pressure-sensitive functions, said digital pen comprising:
a pen core with a tracking module in said digital pen, said tracking module for detecting said pen core shifted in a direction with an optical signal; and
a pressure-sensitive module connected with said pen core, said pressure-sensitive module for detecting said pen core that is under a pressure and is shifted relatively to said digital pen and converting said pressure into an electric signal.

2. The digital pen according to claim 1, wherein said tracking module comprises:
a light source for emitting an incident light beam onto a touch pad in said direction, said touch pad enabling said incident light beam to be reflected as a reflective light beam;
a photosensitive device for accepting said reflective light beam, said photosensitive device having a photosensitive area not parallel to said direction; and
a reflector for conducting said reflective light beam to enter vertically into said photosensitive area.

3. The digital pen according to claim 1, wherein said pressure-sensitive module comprises:
an elastic device capable of forming a deformation by said pressure;
an iron powder core having one terminal connected to center of said pen core through said elastic device, and having the other terminal affixed into said digital pen; and
a conductive coil surrounding said iron powder core, said conductive coil affixed onto said pen core and coordinated with said iron powder core to generate said electric signal through said deformation.

4. The digital pen according to claim 1, wherein said pressure-sensitive module comprises:
an elastic device capable of forming a deformation by said pressure;
an iron powder core affixed onto center of said pen core; and
a conductive coil surrounding said iron powder core, said conductive coil having one terminal connected to said pen core through said elastic device and having the other terminal affixed into said digital pen, said conductive coil coordinated with said iron powder core to generate said electric signal through said deformation.

5. The digital pen according to claim 1, wherein said pressure-sensitive module comprises:
an elastic device capable of forming a deformation by said pressure;
a first structure having one terminal connected to center of said pen core through said elastic device, and having the other terminal affixed into said digital pen, said first structure having a light path through; and
two second structures at sides of said first structure and affixed to said pen core, one of said second structures having a light emitter, the other one of said second structures having a light acceptor, said light emitter and said light acceptor coordinated with said light path to generate said electric signal through said deformation.

6. The digital pen according to claim 1, wherein said pressure-sensitive module comprises:
an elastic device capable of forming a deformation by said pressure;
a first structure affixed to center of said pen core and having a light path through; and
two second structures at sides of said first structure, each said second structure having one terminal connected to said pen core through said elastic device, and having the other terminal affixed into said digital pen, one of said second structures having a light emitter, the other one of said second structures having a light acceptor, said light emitter and said light acceptor coordinated with said light path to generate said electric signal through said deformation.

7. A digital pen capable of handwriting input, said digital pen comprising:
a pen core in said digital pen, said pen core capable of being under an inputted pressure thereby is shifted relatively to said digital pen;
a tracking in said pen core for detecting said pen core shifted in a direction through an optical signal; and
a pressure-sensitive module connected with said pen core for applying a deformation corresponding to said inputted pressure and converting said deformation into an electric signal.

8. The digital pen according to claim 7, wherein said tracking module comprises:
a light source for emitting an incident light beam onto a touch pad in said direction, said touch pad enabling said incident light beam to be reflected as a reflective light beam;
a photosensitive device for accepting said reflective light beam, said photosensitive device having a photosensitive area not parallel to said direction; and
a reflector for conducting said reflective light beam to enter vertically into said photosensitive area.

9. The digital pen according to claim 7, wherein said pressure-sensitive module comprises:
an elastic device capable of forming said deformation by said inputted pressure;
an iron powder core having one terminal connected to center of said pen core through said elastic device, and having the other terminal affixed into said digital pen; and
a conductive coil surrounding said iron powder core, said conductive coil affixed onto said pen core and coordinated with said iron powder core to generate said electric signal through said deformation.

10. The digital pen according to claim 7, wherein said pressure-sensitive module comprises:
an elastic device capable of forming said deformation by said inputted pressure;
an iron powder core affixed onto center of said pen core; and
a conductive coil surrounding said iron powder core, said conductive coil having one terminal connected to said pen core through said elastic device and having the other terminal affixed into said digital pen, said conductive coil coordinated with said iron powder core to generate said electric signal through said deformation.

11. The digital pen according to claim 7, wherein said pressure-sensitive module comprises:
an elastic device capable of forming said deformation by said inputted pressure;
a first structure having one terminal connected to center of said pen core through said elastic device, and having the other terminal affixed into said digital pen, said first structure having a light path through; and
two second structures at sides of said first structure and affixed to said pen core, one of said second structures having a light emitter, the other one of said second structures having a light acceptor, said light emitter and said light acceptor coordinated with said light path to generate said electric signal through said deformation.

12. The digital pen according to claim 7, wherein said pressure-sensitive module comprises:
an elastic device capable of forming said deformation by said inputted pressure;
a first structure affixed to center of said pen core and having a light path through; and
two second structures at sides of said first structure, each said second structure having one terminal connected to said pen core through said elastic device, and having the other terminal affixed into said digital pen, one of said second structures having a light emitter, the other one of said second structures having a light acceptor, said light emitter and said light acceptor coordinated with said light path to generate said electric signal through said deformation.

13. A digital pen capable of handwriting input, said digital pen comprising:
a pen core in said digital pen, said pen core capable of being under an inputted pressure thereby is shifted relatively to said digital pen;
a tracking in said pen core for detecting said pen core shifted in a direction through an optical signal, said tracking module comprising:
a light source for emitting an incident light beam onto a touch pad in said direction, said touch pad enabling said incident light beam to be reflected as a reflective light beam;
a photosensitive device having a photosensitive area for accepting said reflective light beam; and
a reflector for conducting said reflective light beam to enter vertically into said photosensitive area; and
a pressure-sensitive module connected with said pen core for applying a deformation corresponding to said inputted pressure and converting said deformation into an electric signal.

14. The digital pen according to claim 13, wherein said photosensitive area is not parallel to said direction.

15. The digital pen according to claim 13, wherein said pressure-sensitive module comprises:
an elastic device capable of forming said deformation by said inputted pressure;
an iron powder core having one terminal connected to center of said pen core through said elastic device, and having the other terminal affixed into said digital pen; and
a conductive coil surrounding said iron powder core, said conductive coil affixed onto said pen core and coordinated with said iron powder core to generate said electric signal through said deformation.

16. The digital pen according to claim 13, wherein said pressure-sensitive module comprises:
an elastic device capable of forming said deformation by said inputted pressure;
an iron powder core affixed onto center of said pen core; and
a conductive coil surrounding said iron powder core, said conductive coil having one terminal connected to said pen core through said elastic device and having the other terminal affixed into said digital pen, said conductive coil coordinated with said iron powder core to generate said electric signal through said deformation.

17. The digital pen according to claim 13, wherein said pressure-sensitive module comprises:
an elastic device capable of forming said deformation by said inputted pressure;
a first structure having one terminal connected to center of said pen core through said elastic device, and having the other terminal affixed into said digital pen, said first structure having a light path through; and
two second structures at sides of said first structure and affixed to said pen core, one of said second structures having a light emitter, the other one of said second structures having a light acceptor, said light emitter and said light acceptor coordinated with said light path to generate said electric signal through said deformation.

18. The digital pen according to claim 13, wherein said pressure-sensitive module comprises:
an elastic device capable of forming said deformation by said inputted pressure;
a first structure affixed to center of said pen core and having a light path through; and
two second structures at sides of said first structure, each said second structure having one terminal connected to said pen core through said elastic device, and having the other terminal affixed into said digital pen, one of said second structures having a light emitter, the other one of said second structures having a light acceptor, said light emitter and said light acceptor coordinated with said light path to generate said electric signal through said deformation.
